(19) United States
(12) Patent Application Publication
(10) Pub. No.: US 2022/0179766 A1
(43) Pub. Date: Jun. 9, 2022

(54) CHANNEL-BASED MACHINE LEARNING INGESTION FOR CHARACTERIZING A COMPUTERIZED SYSTEM

(71) Applicant: INTERNATIONAL BUSINESS MACHINES CORPORATION, ARMONK, NY (US)

(72) Inventors: Mircea R. Gusat, Langnau am Albis (CH); Charalampos Pozidis, Thalwil (CH); Athanasios Fitsios, Zurich (CH)

(21) Appl. No.: 17/115,837

(22) Filed: Dec. 9, 2020

(51) Int. Cl. G06F 11/34; G06N 3/04

(52) U.S. Cl. CPC G06F 11/3428; G06N 3/04; G06F 11/3419

(57) ABSTRACT

A computer-implemented method, computer program product and computer system of characterizing a computerized system, where data can be written to or read from the system via write channels and read channels. Including accessing first data, pertaining to the write channels, and second data, pertaining to the read channels and may continually collect, aggregate, and access data. The first data and the second data are separately fed into a convolutional or recurrent neural network, which includes two input channels defining independent subsets of one or more layers and an output layer connected by each subsets of layers. Data ingestion is performed for the neural network to separately process the first data and the second data and produce one or more values in the output layer. A current state can be characterized based on the values produced. A potential anomaly is detected in the system, and action may be taken.

### BACKGROUND

The present invention relates to the field of computing, and more particularly to a computer implemented method, data processing system and computer program product for characterizing a computerized system.

### SUMMARY

According to a first aspect, the present invention is embodied as a computer-implemented method of characterizing a computerized system (i.e., an analog or digital system), wherein data can be written to or a read from hardware components of the system via write channels and read channels, respectively. The method comprises accessing two types of data, while the system is being operated. Such data includes first data and second data, which respectively pertain to the write channels (including store and transmit channels) and the read channels (including load and receive channels) of the system. Such data maybe continually collected, aggregated, and then accessed by the method in view of characterizing the computerized system. The first data and the second data accessed are separately fed into a multiple-channel neural network, e.g., a convolutional or recurrent neural network. The neural network notably includes two input channels, which define independent subsets of one or more neuron layers, and an output neuron layer. The output layer is connected by each of the independent subsets of layers, e.g., via one or more intermediate neuron layers. Data ingestion is performed so as for the neural network to separately process the first data and the second data in the independent subsets of neuron layers (as formed by the distinct input channels) and produce one or more values in output of the output layer. This way, the current state of the computerized system can be efficiently characterized based on the one or more values produced by the multiple-channel neural network. The method is preferably performed to detect a potential anomaly in the system, and, if necessary, take action to modify a functioning of the system.

According to another aspect, the invention is embodied as a monitoring system for characterizing a target computerized system. The context is similar to the context assumed in the above method. That is, data can be written to or a read from hardware components of the target system, via write channels and read channels, respectively. The monitoring system basically comprises processing means, a memory, and storage means, which stores computerized methods. The monitoring system is adapted to load the computerized methods in the memory and is accordingly configured to perform steps such as described above. Namely, the monitoring system accesses first and second data as the target system is being operated, and separately feed the accessed data into a multiple-channel neural network, for the latter to separately process the data and produce one or more output values, in operation. The monitoring system is thus able to characterize a current state of the target system based on output values produced by the neural network.

A final aspect of the invention concerns a computer program product, which comprises a computer readable storage medium having program instructions embodied therewith. The program instructions are executable by a plurality of processing means (e.g., of a monitoring system as described above) to cause the latter to implement steps according to the above method.

Computerized systems, methods, and computer program products embodying the present invention will now be described, by way of non-limiting examples, and in reference to the accompanying drawings.

### BRIEF DESCRIPTION OF THE DRAWINGS

The accompanying figures, where like reference numerals refer to identical or functionally similar elements throughout the separate views, and which together with the detailed description below are incorporated in and form part of the present specification, serve to further illustrate various embodiments and to explain various principles and advantages all in accordance with the present disclosure, in which:

FIG. 1 is a flowchart illustrating high-level steps of a method for detecting anomalies in a target computerized system, according to an embodiment. The method is based on timeseries of key performance indicators in this example.

FIG. 2 is a block diagram that schematically illustrates selected components and operations involved during a detection scheme similar to that of FIG. 1, except that the sequence of operations described is now based on data sampled from moving data, i.e., data conveyed along read and write channels of the target system, between hardware components thereof, in an embodiment.

FIG. 3 schematically depicts artificial neuron layers of a multi-channel neural network (here a two-channel convolutional neural network), as involved in an embodiment.

FIG. 4 represents hardware units (i.e., cloud resources and a network monitoring entity) and users of a target computerized system, which may be used to implement method steps as involved in embodiments. I.e., the monitoring entity is adapted to interact with cloud components for detecting anomalies in the target system, in an embodiment.

FIG. 5 represents the architecture of a general-purpose computerized unit that may form part of any computerized unit shown in FIG. 4, suited for implementing one or more method steps as involved in embodiments of the invention.

FIG. 6 depicts a cloud computing environment according to an embodiment of the present invention.

FIG. 7 depicts abstraction model layers according to an embodiment of the present invention.

The accompanying drawings show simplified representations of devices or parts thereof, as involved in embodiments. Similar or functionally similar elements in the figures have been allocated the same numeral references, unless otherwise indicated.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

The present invention relates in general to techniques for characterizing a computerized system such as a network of interconnected computers, e.g., a cloud, or a datacenter. In particular, it is directed to a method where distinct (though potentially correlated) input data, which respectively pertain to read and write channels, are separately fed into correspondingly mapped input channels of a multiple-channel neural network, in view of characterizing a current state of the computerized system and, e.g., detecting anomalies therein.

Machine learning often relies on artificial neural networks, (hereinafter “ANNs”), which are computational models inspired by biological neural networks in human or animal brains. Such systems progressively and autonomously learn tasks by means of examples; they have successfully been applied to, e.g., speech recognition, text processing and computer vision.

An ANN comprises a set of connected units or nodes, which compare to biological neurons in animal brains and are therefore called artificial neurons. An ANN typically involves multiple, connected layers of such artificial neurons. Signals are transmitted along connections (also called edges) between artificial neurons, similarly to synapses. An artificial neuron that receives a signal processes it and then signals connected neurons. Connection weights (also called synaptic weights) are typically associated with the connections and nodes; such weights adjust as learning proceeds. Each neuron may have several inputs and a connection weight is attributed to each input (the weight of that specific connection). Such connection weights are learned by the training algorithm during a training phase and thereby updated. The learning process is iterative: data cases are presented to the network, typically one at a time, or grouped in batches, and the weights associated with the input values are adjusted at each time step via a forward or backward propagation mechanism.

Many types of neural networks are known, starting with feedforward neural networks, such as multilayer perceptrons, deep neural networks, and convolutional neural networks, (hereinafter “CNNs”), where the latter rely on convolution operations. Also known are recurrent neural networks, (hereinafter “RNNs”), wherein connections between the nodes form a directed graph along a temporal sequence, allowing the RNN to have a dynamic (temporal) behavior. Neural networks are typically implemented in software. However, a neural network may also be implemented in analog and/or digital hardware, e.g., as a resistive processing unit or an optical neuromorphic system.

Characterizing a state of a computer system is needed for many applications, e.g., to detect anomalies in or malfunctions of the system. Two prevalent approaches in designing anomaly detection systems are known, which are based on signatures or behaviors of the data traffic or behavior (e.g., based on timeseries). Signature-based detection relies on the existence of a collection of known events, novelty, or attack signatures that get updated every time a new attack is found. Behavioral detection may be useful in defending against novel malicious behaviors, for which signatures are not available yet. This type of detection typically involves machine learning to create profiles for behaviors of the normal network traffic. The profiles are used to detect anomalies (e.g., novelties or outliers), i.e., traffic having a behavior that significantly diverges from a norm. A merit of this approach is that it can operate without prior knowledge or traffic assumptions, often being unsupervised in nature. It is, however, a challenge to design behavioral detection methods that are both accurate and performant (in terms of sensitivity, relevance, and detection speed), e.g., to allow fast and accurate online inferences.

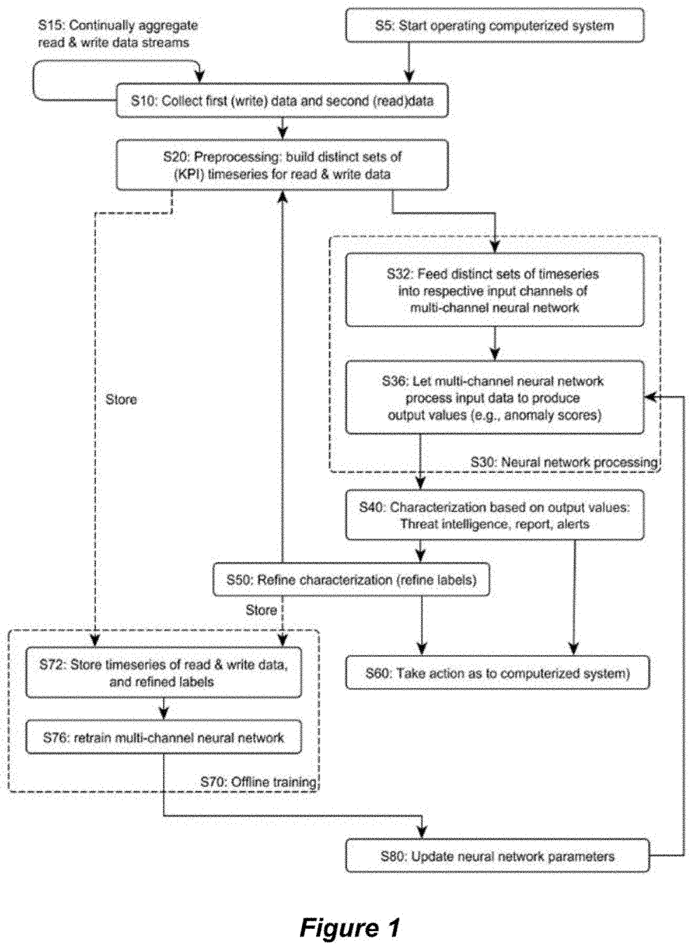

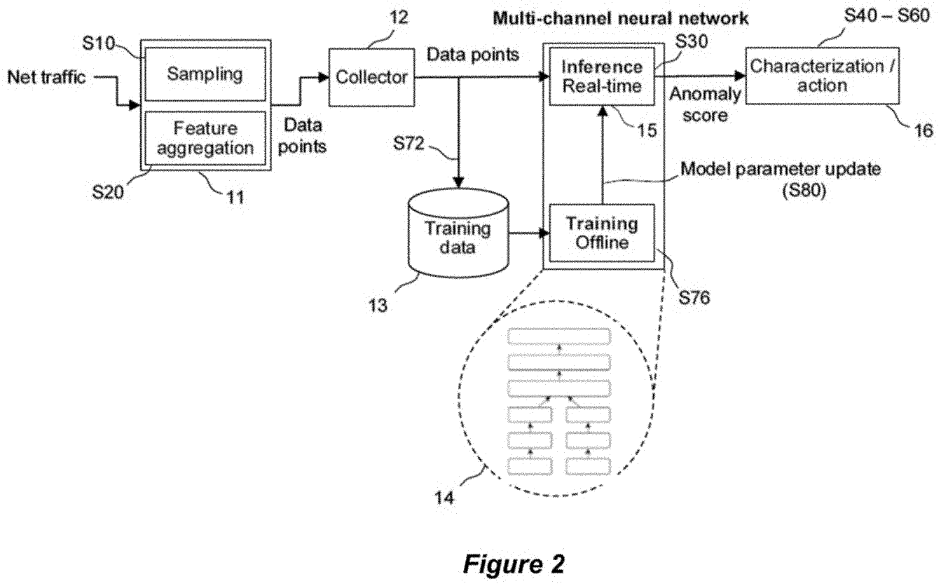

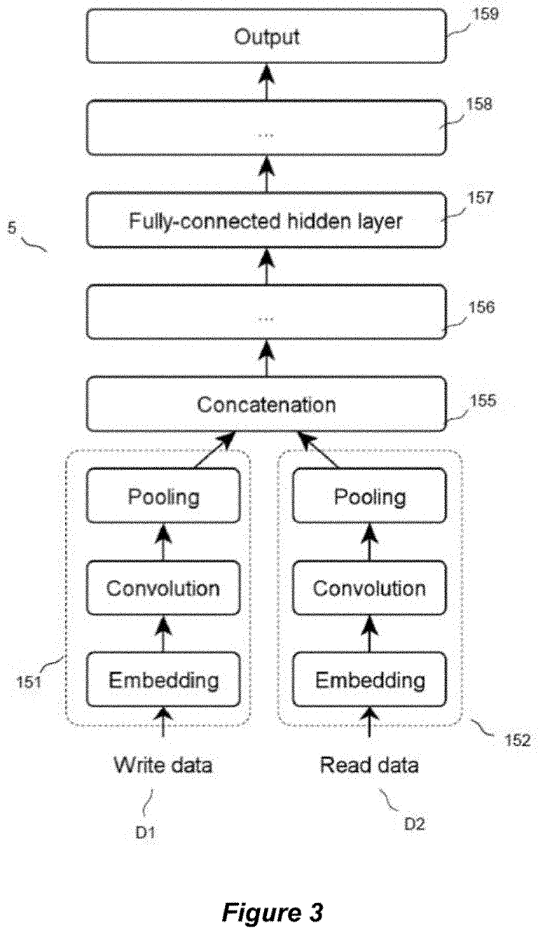

In reference to FIGS. 1-7, an aspect of the invention is first described, which concerns a computer-implemented method of characterizing a computerized system 20. The present method and its variants are collectively referred to as “the present methods”. All references Sij refer to methods steps of the flowchart of FIG. 1 (some of which are also visible in FIG. 2), while numeral references pertain to the abstract neural network structure shown in FIG. 3, or computerized entities, or physical parts or components thereof, as shown in FIGS. 2 and 4-7.

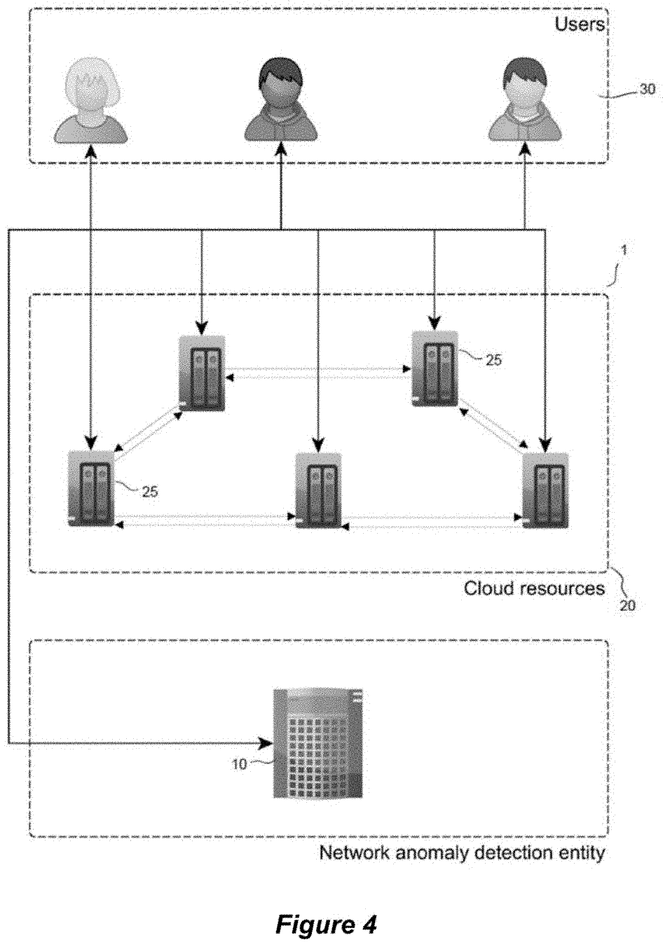

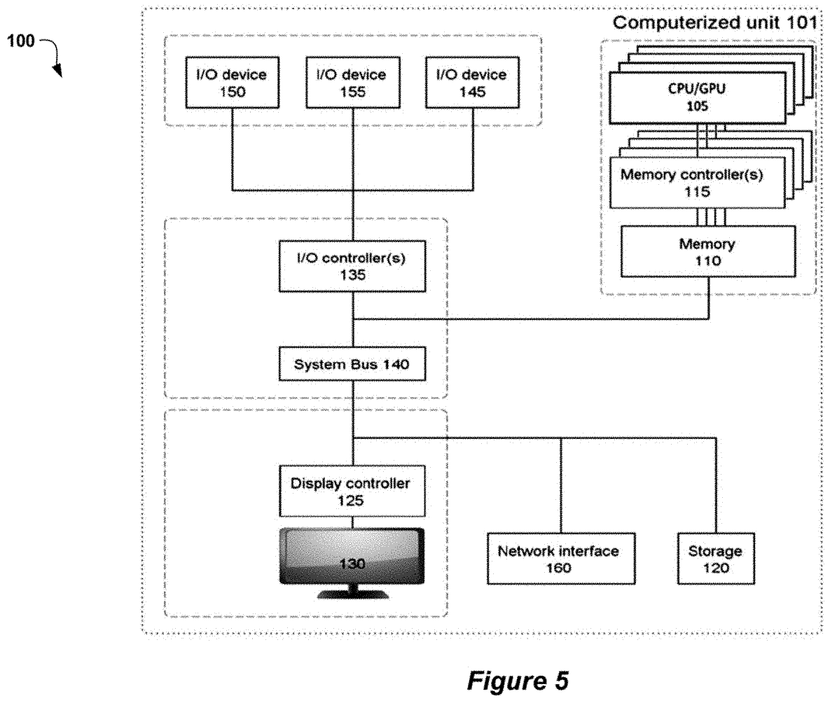

FIG. 1 is a flowchart illustrating high-level steps of a method for detecting anomalies in a target computerized system, according to an embodiment. The method is based on timeseries of key performance indicators in this example. FIG. 2 is a block diagram that schematically illustrates selected components and operations involved during a detection scheme similar to that of FIG. 1, except that the sequence of operations described is now based on data sampled from moving data, i.e., data conveyed along read and write channels of the target system, between hardware components thereof, in an embodiment. FIG. 3 schematically depicts artificial neuron layers of a multi-channel neural network (here a two-channel convolutional neural network), as involved in an embodiment. FIG. 4 represents hardware units (i.e., cloud resources and a network monitoring entity) and users of a target computerized system, which may be used to implement method steps as involved in embodiments. I.e., the monitoring entity is adapted to interact with cloud components for detecting anomalies in the target system, in an embodiment. FIG. 5 represents the architecture of a general-purpose computerized unit that may form part of any computerized unit shown in FIG. 4, suited for implementing one or more method steps as involved in embodiments of the invention

A target computerized system 20 may include various hardware components. Such components may be computerized units, such as nodes 25 of a network (or cloud resources) 20 (FIG. 4), or internal hardware components 105, 110 of one or more computerized units 101 such as shown in FIG. 5. In all cases, the operation of the target system 20 results in data that can be written to or read from nodes or hardware components 25 of the system 20, or 105, 110 of the computerized unit 101, via write channels and read channels, respectively, of the system 20.

A method proceeds as follows: two types of data D1, D2 are accessed S10, S15 and S20 as the system 20 is being operated, start operating computerized system, S5, as shown in FIGS. 1 and 2. Collect first (write) data, D1, and second (read) data, D2, step S10. Next, preprocessing build distinct sets of key performance indicators (KPIs) timeseries for read and write data, S20.

Such data may for example be repeatedly accessed, to continually probe the system 20, S15, continually aggregate read and write data streams. Such data includes first data D1 and second data D2, which respectively pertain to write channels and read channels of the system 20. As such, the first and second data, D1 and D2, may potentially be correlated, spatially and/or temporally. Different types of input data and data structures may be used, as discussed later in detail.

The first data D1 and the second data D2 accessed are separately fed S32 into a multiple-channel neural network 15, such as a convolutional neural network, (hereinafter “CNN”), or a recurrent neural network, (hereinafter “RNN”), as shown in FIG. 3. Feed distinct sets of timeseries into respective input channels of multi-channel neural network, S32, FIG. 1. That is, the neural network 15 includes two input channels 151, 152, as seen in FIG. 3. The input channels define independent subsets of one or more neuron layers. The neural network 15 further includes an output neuron layer 159, which is connected by each of the independent subsets of layers. The neural network 15 may include a number of additional layers, shown as fully-connected hidden layer 155, 156, 157 and 158, as shown in FIG. 3. Feeding data D1, D2 into the neural network 15 makes it possible to separately process S36 (FIG. 1) the first data D1 and the second data D2 in the independent subsets of layers defined in the input channels 151, 152, and then jointly process merged data in subsequent layers 155-159 of the neural network 15, to eventually produce one or more output values, i.e., in output of layer 159. At S36, multi-channel neural network process input data to product output values, e.g. anomaly scores, FIG. 1.

Eventually, the current state of the computerized system 20 is characterized S40, S50 based on the values produced S36 by the neural network, FIG. 1. The system 20 may notably be characterized in view of detecting a potential anomaly, a malfunction, or a given (e.g., a new) status of the system 20, etc., in view of taking any appropriate measure in respect of the system 20, as exemplified later.

The computerized system 20 typically has a von Neumann architecture, whereby hardware components 25, 105, 110 of the system 20 are interconnected through signal lines, F FIGS. 4 and 5. When such hardware components are internal components 105, 110 of a same hardware unit, such signal lines correspond to the so-called buses. The main buses are the control bus, the data bus, and the address bus, each allowing for parallel data transmission between the various hardware components. The address bus identifies memory locations (storage 120) and I/O devices 145, 150, 155 of the hardware entity. The control bus routes signals allowing the CPU to communicate with the memory or storage 120 and the I/O devices 145, 150, 155, see FIG. 5. The data bus is bidirectional, so as to send data to or from a given component. Thus, each hardware component may exchange data with other components via a pair of channels. Such channels refer to logical channels and may not necessarily require independent physical channels.

The same principle extends to interconnected entities 25, such as nodes (or switches) of a network 20, wherein data is exchanged between components 25 via pairs of channels (depicted as dashed arrows in FIG. 4). In both cases, each pair of channels include a write channel and a read channel. Note, read and write channels should be understood in a broad sense. E.g., write channels may notably include store and transmit channels, while read channels may include load and receive channels, for example. Several write channels and several read channels are likely involved in operation of the computerized system 20. Such channels normally refer to logical channels and may not necessarily require independent physical channels, it being noted that data exchanged on a physical channel are often time-multiplexed.

Data consumed and produced by the hardware components 25, 105, 110 (via the write and read channels, respectively) can be referred to as read data and write data. They are also referred to as “direct data” in the present context, as opposed to “indirect data”. Beyond direct data, other types of data are normally involved, which may be used to characterize the state of the system 20 as well. Indirect data may notably include data used by the system 20 to ensure execution of the normal processes, such as control data, e.g., indicative of traffic state, congestion, etc. And indirect data too may be classified as primarily relating to write channels or read channels of the system 20. Accordingly, any or each of the direct data and indirect data may be used to define quantities of interest, for each type of channel, and serve as measurand of a state of the system.

The first layers (including, e.g., convolutional layers) in the distinct input channels 151, 152 of the neural network 15 serve to extract features of the input data. This typically results in forming feature vectors or feature maps, as discussed later in detail. Extracted features are typically processed through additional layers in the input channels 151, 152 of the neural network 15, FIG. 3, before being merged 155 and passed to one or more fully connected layers 156, 157, 158 of the neural network 15, to eventually produce one or more output values. I.e., signals are merged in a layer of the network 15, typically in an intermediate layer 155, upstream of the output layer 159, as assumed in FIG. 3.

The output values produced by the neural network 15 may embody predictions, classifications, or may be used to compute additional quantities, so as to characterize the current state of the system 20. The characterization 16 steps S40, S50 are at least partly automatic, FIG. 1. The characterization 16 performed is to be understood in a broad sense; it may notably aim at learning or modeling quantities characterizing the system. For example, instead of simply reporting output values, which may for example include anomaly scores, the characterization 16 performed may automatically classify S40 the anomaly scores as harmful or non-harmful. In embodiments, a subset of the anomaly scores (typically the majority of them) are automatically classified at step S40. However, minimal human intervention may be needed to further refine S50, or confirm/infirm S50, a residual portion of the anomaly scores obtained. This can notably be used for re-training S76 a neural network 14 offline, FIG. 2, such that the neural network 15 used for online inferences may be regularly updated S80, as seen in FIGS. 1 and 2. This way, updated neural network parameters are continually passed to the network 15 used for online inferences.

A single neural network 15, FIG. 2, is used for online inference in the present case, rather than using two distinct neural networks for the two types of data D1, D2. Thus, useful correlations between the two types of data D1, D2 can safely be detected by the neural network 15 upon processing input values. However, the structure of the neural network 15 allows a parallel ingestion of input data, such that data fed in the different channels 151, 152 independently traverse subsets of layers of the neural network 15, with a benefit in terms of processing time. This is particularly advantageous when willing to characterize, e.g., in real time, the state of a complex system such as a datacenter, a cloud of computers, and, more generally, a network of interconnected computers.

Note, more than two channels may possibly be involved, e.g., for ingesting data pertaining to control buses and address buses, for example. However, in preferred embodiments, two channels 151, 152 are primarily relied upon (i.e., which are mapped to data pertaining to the read and write channels of the system 20).

All this is now described in detail, in reference to preferred embodiments of the invention.

To start with, referring to FIGS. 1 and 2, steps S40 and S50 are preferably carried out to detect a potential anomaly in the system 20, as noted above. Anomalies in non-stationary data may generally relate to data traffic anomaly, such as network attacks (e.g., on the business environment), unauthorized accesses, network intrusions, improper data disclosures or data leakages, system malfunctions, or data and/or resources deletion, etc.

For example, an anomaly score can be computed S40 based on values produced S36 by the neural network 15, e.g., as an analytic function of the output values, according to a given metric. In variants, an output value produced S36 by the neural network 15, at each inference step, may already be representative of an anomaly score, assuming that the neural network was designed and trained therefor. In other variants, one or more quantities may be automatically computed at step S40 based on the values produced S36 by the neural network. The computed values may then be used to compute the anomaly score, according to a suitable metric. Anomalies may thus be detected based on predictions or classifications performed by outer layers of the neural network 15. And as the skilled person will realize, a number of further variants can be contemplated. Anomaly detection is important for diverse domains: cybersecurity, fraud detection, healthcare, etc. Anomalies may be malicious actions, frauds, or system failures.

In variants to anomaly scores, other figures of merit may be computed at step S40, such as a precision, a recall, an F1-score, a receiver operating characteristic (ROC), or the area under the receiver operating characteristic (AUROC), etc.

Once a current state of the system 20 has been duly characterized S40, S50, appropriate decision may be made, e.g., in the interest of preserving the system 20 and/or its environment. In particular, action may be taken S60 in respect of the system 20. Both the type of action taken and its intensity may depend on the output values produced at step S36 or on additional quantities computed based on such output values. For example, a preemptive action may be taken, to preempt or forestall adverse phenomena. E.g., in case in anomaly is detected, some of the data traffic may be interrupted, re-routed, deleted, or even selected parts of the computerized system 20 may be shut down, as necessary to deal with the anomaly detected. More generally, actions taken modify the way the system 20 normally functions.

Practically speaking, an anomaly typically corresponds to an occurrence where, at a certain point in time, one or more attributes' values deviate from their usual values. E.g., a given attribute value may for instance deviate from the distribution of values as usually observed in the past for this given attribute, in the context defined by other attributes. The occurrence of an anomaly may for example be attributed to an unknown or known exogenous variable. For example, a spike in the web traffic for the term “firecrackers” may safely be classified as a non-anomaly if the model includes yearly data, whereby this spike is just an expected periodic recurrence. Now, when an outlier is observed with an unknown exogenous factor, it may be concerning since it can be a fraudulent activity. Furthermore, such points do not have any regularity. Ideally, in the present case, one would also want to detect attribute outliers in the context of its neighbors, which do not have any periodicity and mark them as anomalies, hence the potential benefits of convolutional neural networks (CNNs).

Thus, in embodiments, the neural network 15 is a multi-channel CNN (as assumed in FIG. 3), which uses convolution in place of mere matrix multiplication in at least some of its layers, and, this, already in each input channel 151, 152. Technically, the convolution operations involved involve sliding dot products and/or cross-correlations. For each data point on the input, a value is calculated using a convolution operation based on a filter. Several convolution filters may possibly be used, contrary to the simple scenario assumed in FIG. 3. After filters have passed over the input data, a feature map is generated for each filter (feature learning). This results in feature maps, which are then likely pooled (to reduce dimensions), prior to being merged (or concatenated) 155 to feed a fully-connected (dense) layer 156. Merged features are thus further processed by final layers (e.g., including fully connected layers) 156-158, the parameters of which have been trained to perform classifications or predictions based on earlier extracted features, for example. In other words, A CNN kernel looks for specific features in the data. When the kernel is applied in parallel in each channel, patterns of related features can be extracted independently in each channel, prior to being merged in a subsequent layer, to produce useful output values.

A CNN can advantageously be used for the parallel processing of semantically related channels in the CNN layer. That is, similar or related information can be seen by the CNN from different perspectives similarly to different colors of an image. Such information may notably include data subject to read/write operations, e.g., data related to receive (Rx)/transmit (Tx) signals, etc. More generally, data fed into the input channels relate to the read and write channels, as indicated earlier.

More generally, other types of ANNs may be used, with an arbitrary number of layers, a subset of which are organized in distinct input channels, focused on learning spatial correlations from the input channels.

In variants, the neural network 15 is a recurrent neural network, which can notably be exploited to learn temporal correlations between data fed in each of the input channels. Here, signals with similar historical patterns (e.g., based on seasonality, or the autocorrelation function of such data) may be grouped, per channel, for temporal processing. The high-level structure of the RNN is nevertheless similar to the network shown in FIG. 3, inasmuch as the network includes at least two input channels for separately ingesting input data D1, D2.

In other variants, heterogeneous channels may be involved. For example, two channels may use convolution layers, while an additional channel may involve a multiplayer perceptron (not shown).

As indicated earlier, the first and second data D1, D2 may notably include direct data, i.e., data as transmitted along the read and write channels, in view of reading some data from the hardware components (i.e., data produced by such components) or write data to such components (which therefore consume such data). Direct data can be accessed S10, FIGS. 1 and 2, by sampling data transmitted along data paths to and from the hardware components 25, respectively, through the write channels and the read channels. Data sampling mechanisms are known per se. Direct data may notably be obtained via control paths of the system 20.

Direct data collected S10 by sampling the read and write channels includes moving data (e.g., data sent by nodes 25 of a cloud 20 to other nodes 25), as opposed to static data (e.g., data that is statically stored on resources of the cloud). At any time tₖ, data going to a given hardware component of the system 20 via a write channel differs from data coming from the given component on the read channel. For example, direct data may include read/write data from/to a same CPU, a same storage element, or a same memory system. Information conveyed on the read and write channels to a given component likely differs, at any time. Reasons for this may notably be due to: (i) a time lag; (ii) reading from an address space, processing, and then writing to another address space; or (iii) inherent processing, whereby information is added, removed, or transformed.

Note, in some particular cases, the data contents as sampled on a pair of read/write channels may include identical contents. However, such contents will be shifted, be it in terms of time or address space. There, the amount and nature of the shifting may be learned by the machine learning model to detect anomalies or to predict future behaviors. Thus, additional data (such as timestamps and addresses) may advantageously be used, in addition to direct data, to build input data D1, D2 pertaining to write and read channels.

There are at most N(N−1)/2 channel pairs and N(N−1) channels (including read and write channels) involved for N interconnected hardware components. Given that the machine learning model should much preferably not ingest the same information twice (but only once), direct data is preferably sampled from the N(N−1) channels. This typically leads to N(N−1) input features (or sets of input features) for each time tₖ considered. Input features may for example be formed as vectors of features, also called data point, by aggregating data sampled from data flows in the read and write channels.

For instance, FIG. 2 describes a scenario in which data from a network traffic is sampled S10 at regular time intervals and then aggregated S20, using a module 11. For each sampling time tₖ, the data points (vectors of aggregated features) formed S20 are passed to a collector 12. Such data points are fed into the neural network 15 for online inferences S30, which produces output values. Such values may for example be anomaly scores, based on which the system is next characterized S40 and S50. If necessary, an appropriate step is taken (not shown, see FIG. 1), in respect of the system 20. Moreover, minimal (or partial) human intervention may be involved after step S30 to validate S50 a selected subset of the output produced S30 online (see FIG. 1). The data collected by the element 12 are further stored on a repository 13, in view of training another instance 14 of the neural network 15, offline, based on labels as produced S30 and S40 and then confirmed at step S50. This way, the neural network 15 can regularly be updated S80 based on neural network parameters updated S76 offline.

In variants to direct data, or in addition to direct data, the first data D1 and the second data D2 include indirect data, e.g., data characterizing data traffic in the write channels and the read channels as the system 20 is being operated. In that case, the first and second data indirectly relate to the write and read channels. Traffic data may for example include sensor data about monitored read/write processes. Beyond traffic data, indirect data may more generally relate to data communication and/or patterns of moving data, dynamic events occurring in the computerized system 20, this including network intrusions. Note, such data may for instance include encrypted data, e.g., end-to-end encoded or encapsulated data flows, streams, or timeseries. In preferred embodiments, each of the two types of data D1, D2 accessed at steps S10, S15 and S20 includes one or more timeseries. Note, timeseries may in fact be built based on direct and/or indirect data.

For example, indirect data may include key performance indicators (KPIs) that pertain to each of the read channels and the write channels, as assumed in FIG. 1. Preferably, between 2 and 800 KPIs are used. KPIs are computed S20 based on data collected S10 from the computerized system 20, based on any suitable metric. E.g., streaming KPIs may be considered. The KPIs formed will preferably form timeseries. In particular, indirect data may include multiple timeseries for multiple KPIs, respectively, where each timeseries corresponds to a given KPI. E.g., the timeseries are aggregated S20 based on data collected S10 at regular time intervals, from the system 20. Univariate or multivariate timeseries may accordingly be collected and aggregated for several KPI metrics, e.g., at a frequency of 288 times per day (i.e., every 300 s). Such a frequency happens to be a practical upper bound of common long short-term memory (LSTM), gated recurrent unit (GRU), and RNN memories. Any longer period would require a special mechanism, such as the so-called skip, attention, or temporal convolutional network (TCN)/dilated CNN mechanisms. The above approach may be used for monitoring general computers, as well as memory and storage hardware, and load/store engines, for example. In other approaches, data collected at step S10 may need be up/sub-sampled, in order to form S20 timeseries.

The flowchart shown in FIG. 1 assumes the use of KPIs. After starting S5 the system 20, data D1, D2 is continually S15 collected S10 from the system 20 and processed S20 to build KPI timeseries. The latter are stored S72 on a repository (see FIG. 2) 13 in view of (re-)training S76 the neural network 14 offline S70, as explained above. In addition, the timeseries of KPIs formed S20 are continually fed S32 into input channels of the neural network 15, for the latter to produce S36 output values. A first level of characterization (fully automatic) is performed S40 based on output values produced S36 online by the neural network 15. As explained above, a selection of the results obtained may be refined S50 with human intervention. The outcomes of such characterization 16 steps S40, S50 are labels that are stored S72 on the unit 13, together with the corresponding KPIs, in view of retraining S76 the neural network 14 and eventually update S80 parameters of the neural network 15 used for online inferences S30. Depending on outcomes of steps S40 and S50, action may need be taken S60 in respect of the system 20, as noted earlier.

Referring to FIGS. 4 and 5, another aspect of the invention is now described, which concerns a monitoring system 10 for characterizing a target computerized system 20. Main features of the system 20 have already been described earlier: the system 20 allows data to be written to or a read from hardware components 25 thereof, via write channels and read channels, respectively. The monitoring system 10 basically comprises processing means 105, a memory 110, and storage means 120 that stores computerized methods. The monitoring system 10 is adapted to load the computerized methods in the memory 110, so as for the monitoring system 10 to implements steps of the present methods, i.e., access data D1, D2, and separately feed the data accessed into a multiple-channel neural network 15. The latter accordingly produces output values, based on which the system 10 is able to characterize a current state of the target system 20.

Characterization may for example proceed by evaluating an anomaly score based on output values produced by the neural network, as explained earlier. The monitoring system 10 may further be designed to take action or instruct to take action in respect of the target system 20, this depending on the output values produced by the neural network 15, in operation.

In embodiments, the monitoring system 10 is further configured to access data D1, D2 by sampling data transmitted along data paths to and from hardware components 25 of the target system 20, through the write channels and the read channels. In variants, the monitoring system 10 may include sensors (analog, digital, of software's) to obtain indirect data about read and write channels, as discussed earlier.

For example, FIG. 4 schematically represents a composite system 1, which comprises a network monitoring entity 10 and a target computerized system 20. The latter is a network of interconnected computerized units 25, e.g., a cloud. In that case, the nodes 25 store and deploy resources, so as to provide cloud services, e.g., for users 30, which may include companies or other large infrastructures.

The monitoring entity 10 is implemented in software executing on a hardware unit that is assumed to be distinct from the nodes 25 of the target system 20 in the example of FIG. 4. The monitoring system 10 is adapted to interact with hardware components 25 of the cloud 20, in view of detecting S30-S50 anomalies in the cloud and take S60 appropriate actions in respect of the system 20. In variants, the monitoring system 10 may actually form part of the target system 20. The tasks performed by this entity 10 may for instance be delocalized over nodes 25 of the network 20. In all cases, other network entities (not shown) may possibly be involved, such as traffic monitoring entities (packet analyzers, etc.), in view of extracting data to be fed into the neural network 15.

Note, any of the computerized units 10 and 25 may be a unit 101 such as shown in FIG. 5. This unit 101 is described in detail in section 2.2. Additional aspects of the monitoring system 10 are described in section 2.1.

A final aspect of the invention concerns a computer program product for characterizing a computerized system. Essentially, the computer program product comprises a computer readable storage medium having program instructions embodied therewith. Such program instructions are executable by a plurality of processing means 105, such as processors of system 10 as described above, to cause the latter to implement steps according to the present methods. Additional aspects of computer program products are described in section 2.2.

The above embodiments have been succinctly described in reference to the accompanying drawings and may accommodate a number of variants. Several combinations of the above features may be contemplated. Examples are given in the next section.

### 2. Specific Embodiments—Technical Implementation Details

2.1 Computerized Systems and Devices

Computerized systems and devices can be suitably designed for implementing embodiments of the present invention as described herein. In that respect, it can be appreciated that the methods described herein are largely non-interactive and automated. In exemplary embodiments, the methods described herein can be implemented either in an interactive, a partly-interactive, or a non-interactive system. The methods described herein can be implemented in software, hardware, or a combination thereof. In exemplary embodiments, the methods proposed herein are implemented in software, as an executable program, the latter executed by suitable digital processing devices. More generally, embodiments of the present invention can be implemented wherein virtual machines and/or general-purpose digital computers, such as personal computers, workstations, etc., are used.

For instance, the system 100 depicted in FIG. 5 schematically represents a computerized unit 101 (e.g., a general- or specific-purpose computer), which may interact with other, similar units 101, so as to be able to perform steps according to the present methods.

In exemplary embodiments, in terms of hardware architecture, as shown in FIG. 5, each unit 101 includes at least one processor 105, and a memory 110 coupled to a memory controller 115. Several processors (CPUs, and/or GPUs) may possibly be involved in each unit 101. To that aim, each CPU/GPU may be assigned a respective memory controller, as known per se.

One or more input and/or output (I/O) devices 145, 150, 155 (or peripherals) are communicatively coupled via a local input/output controller 135. The input/output controller 135 can be coupled to or include one or more buses and a system bus 140, as known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processors 105 are hardware devices for executing software, including instructions coming as part of computerized tasks triggers by the iterative ML algorithm. The processors 105 can be any custom made or commercially available processor(s). In general, they may involve any type of semiconductor-based microprocessor (in the form of a microchip or chip set), or generally any device for executing software instructions.

The memory 110 typically includes volatile memory elements (e.g., random-access memory), and may further include nonvolatile memory elements. Moreover, the memory 110 may incorporate electronic, magnetic, optical, and/or other types of storage media.

Software in memory 110 may include one or more separate programs, each of which comprises executable instructions for implementing logical functions. In the example of FIG. 5, instructions loaded in the memory 110 may include instructions arising from the execution of the computerized methods described herein in accordance with exemplary embodiments. The memory 110 may further load a suitable operating system (OS). The OS essentially controls the execution of other computer programs or instructions and provides scheduling, input-output control, file and data management, memory management, and communication control and related services.

Possibly, a conventional keyboard and mouse can be coupled to the input/output controller 135. Other I/O devices 145, 150, 155 may be included. The computerized unit 101 can further include a display controller 125 coupled to a display 130. Any computerized unit 101 will typically include a network interface or transceiver 160 for coupling to a network, to enable, in turn, data communication to/from other, external components, starting with other units 101 subtending the distributed environment.

The network transmits and receives data between a given unit 101 and other devices 101. The network may possibly be implemented in a wireless fashion, e.g., using wireless protocols and technologies, such as Wifi, WiMax, etc. The network may notably be a fixed wireless network, a wireless local area network (LAN), a wireless wide area network (WAN), a personal area network (PAN), a virtual private network (VPN), an intranet or other suitable network system and includes equipment for receiving and transmitting signals. Preferably though, this network should allow very fast message passing between the units.

The network can also be an IP-based network for communication between any given unit 101 and any external unit, via a broadband connection. In exemplary embodiments, network can be a managed IP network administered by a service provider. Besides, the network can be a packet-switched network such as a LAN, WAN, Internet network, an Internet of things network, etc.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access a normalized search engine or related data available in the cloud. For example, the normalized search engine could execute on a computing system in the cloud and execute normalized searches. In such a case, the normalized search engine could normalize a corpus of information and store an index of the normalizations at a storage location in the cloud. Doing so allows a user to access this information from any computing system attached to a network connected to the cloud (e.g., the Internet).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

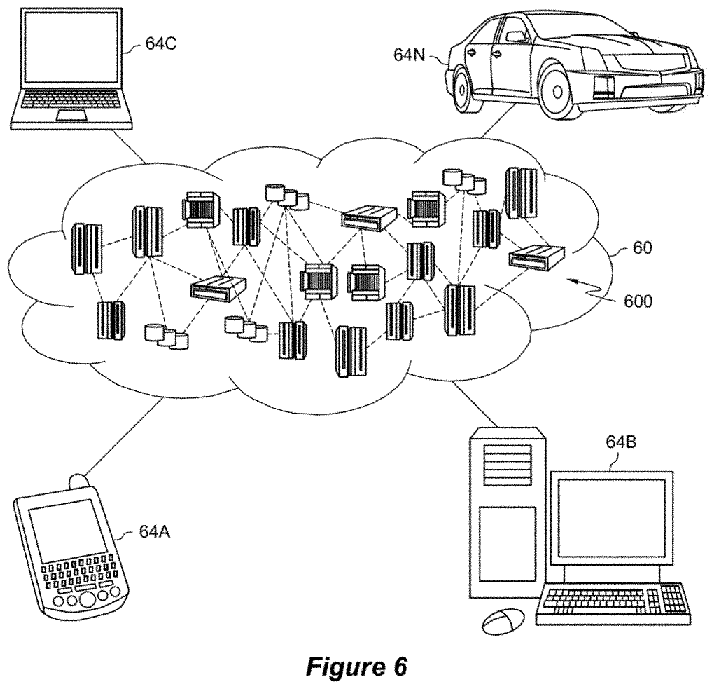

Referring now to FIG. 6, illustrative cloud computing environment 600 is depicted. As shown, cloud computing environment 600 includes one or more cloud computing nodes 610 with which local computing devices used by cloud consumers, such as, for example, personal digital assistant (PDA) or cellular telephone 640A, desktop computer 640B, laptop computer 640C, and/or automobile computer system 640N may communicate. Cloud computing nodes 610 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 640A-N shown in FIG. 6 are intended to be illustrative only and that cloud computing nodes 610 and cloud computing environment 600 can communicate with any type of computerized device over any type of network and/or network addressable connection (e.g., using a web browser).

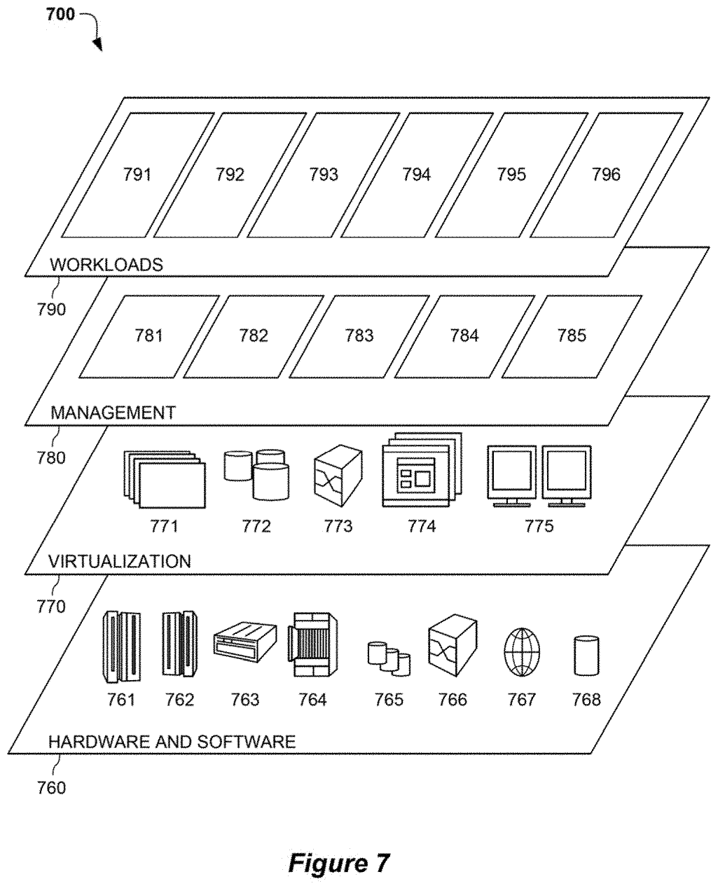

Referring now to FIG. 7, a set of functional abstraction layers provided by cloud computing environment 600 (as shown in FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 760 includes hardware and software components. Examples of hardware components include: mainframes 761; RISC (Reduced Instruction Set Computer) architecture based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772, for example the data storage device 120 as shown in FIG. 5; virtual networks 773, including virtual private networks; virtual applications and operating systems 774; and virtual clients 775.

In an example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In an example, these resources may include application software licenses. Security provides identity verification for cloud consumers and tasks, as well as protection for data and other resources. User portal 783 provides access to the cloud computing environment for consumers and system administrators. Service level management 784 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and characterization program 796. The characterization program 796 may use machine learning to identify an anomaly of a computer program.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of characterizing a computerized system, wherein data can be written to or a read from hardware components of the system via write channels and read channels, respectively, the method comprises:
as the system is being operated, accessing two types of data, including first data pertaining to the write channels and second data pertaining to the read channels;
separately feeding the first data and the second data accessed into a multiple-channel neural network, which includes two input channels defining independent subsets of one or more neuron layers and an output neuron layer, the latter connected by each of the independent subsets of layers, for the neural network to separately process the first data and the second data in the independent subsets of layers and produce one or more values in output of the output layer; and
characterizing a current state of the computerized system based on the one or more values produced.

2. The method according to claim 1, wherein
characterizing the current state of the computerized system comprises detecting an anomaly in the system, based on the one or more values produced.

3. The method according to claim 1, wherein
the method further comprises instructing to take action in respect of the computerized system, based on the one or more values produced to modify a functioning of the computerized system.

4. The method according to claim 1, wherein
the neural network is a convolutional neural network.

5. The method according to claim 1, wherein
the neural network is a recurrent neural network.

6. The method according to claim 1, wherein
accessing the first data and the second data comprises sampling data transmitted along data paths to and from the hardware components, respectively, through the write channels and the read channels.

7. The method according to claim 1, wherein
the first data and the second data accessed comprises data characterizing data traffic in the write channels and the read channels, respectively, as the system is being operated.

8. The method according to claim 1, wherein
each of the two types of data accessed comprises key performance indicators computed based on data collected from the computerized system.

9. The method according to claim 1, wherein
each of the two types of data accessed comprises one or more timeseries.

10. The method according to claim 9, wherein
each of the two types of data accessed includes multiple timeseries, each of the timeseries corresponding to a respective key performance indicator.

11. The method according to claim 9, wherein accessing the two types of data further comprises aggregating data collected from the computerized system to form the timeseries.

12. A monitoring system for characterizing a target computerized system, wherein data can be written to or a read from hardware components of the target system via write channels and read channels, respectively, the monitoring system comprising:
one or more processors, one or more computer-readable memories, one or more computer-readable tangible storage medium, and program instructions stored on at least one of the one or more tangible storage medium for execution by at least one of the one or more processors via at least one of the one or more memories,
wherein the monitoring system is adapted to load the computerized methods in the memory, whereby the monitoring system is configured to:
access two types of data, as the target system is being operated, the two types of data including first data pertaining to the write channels and second data pertaining to the read channels of the target system;
separately feed the first data and the second data accessed into a multiple-channel neural network, the latter including two input channels defining independent subsets of one or more neuron layers and an output neuron layer, the latter connected by each of the independent subsets of layers, for the neural network to separately process the first data and the second data in the independent subsets of layers and produce one or more values in output of the output layer; and
characterize a current state of the target system based on the one or more values produced by the neural network.

13. The monitoring system according to claim 12, wherein
the monitoring system is further configured to access the two types of data by sampling data transmitted along data paths to and from the hardware components of the target system through the write channels and the read channels.

14. The monitoring system according to claim 12, wherein
the monitoring system is further configured to characterize the computerized system by evaluating an anomaly score based on the one or more values produced.

15. The monitoring system according to claim 12, wherein
the monitoring system is further configured to instruct taking action in respect of the target system, based on the one or more values produced, in operation to modify a functioning of the target system.

16. A computer program product for characterizing a computerized system, wherein
data can be written to or a read from hardware components of the system via write channels and read channels, respectively, the computer program product comprising a computer readable storage medium having program instructions embodied therewith, the program instructions executable by a plurality of processing means to cause the latter to:
access two types of data as the computerized system is being operated, the accessed data including first data pertaining to the write channels and second data pertaining to the read channels;
separately feed the first data and the second data accessed into a multiple-channel neural network, the latter including two input channels defining independent subsets of one or more neuron layers and an output neuron layer, the latter connected by each of the independent subsets of layers, for the neural network to separately process the first data and the second data in the independent subsets of layers and produce one or more values in output of the output layer; and
characterize a current state of the computerized system based on the one or more values produced.

17. The computer program product according to claim 16, wherein
the program instructions are further designed to cause the processing means to characterize the computerized system by evaluating an anomaly score based on the one or more values produced.

18. The computer program product according to claim 16, wherein
the program instructions are further designed to cause the processing means to sample data transmitted along data paths to and from said hardware components, respectively, through the write channels and the read channels.

19. The computer program product according to claim 16, wherein
the program instructions are further designed to cause the processing means to aggregate data to form timeseries, for each of the two types of data accessed to include one or more timeseries.
